(19) United States
(12) Patent Application Publication
(10) Pub. No.: US 2014/0369849 A1
(43) Pub. Date: Dec. 18, 2014

(54) COMPOSITE FIBRE COMPONENT FOR A ROTOR BLADE, DEVICE FOR MANUFACTURING A COMPOSITE FIBRE COMPONENT FOR A ROTOR BLADE AND THE METHOD FOR MANUFACTURING A COMPOSITE FIBRE COMPONENT FOR A ROTOR BLADE

(71) Applicant: SENVION SE, Hamburg (DE)

(72) Inventor: Christian Flach, Schacht Audorf (DE)

(21) Appl. No.: 14/475,903

(22) Filed: Sep. 3, 2014

Related U.S. Application Data
(63) Continuation of application No. PCT/EP2013/000587, filed on Feb. 28, 2013.

(30) Foreign Application Priority Data
Mar. 27, 2012 (DE) 10 2012 204 858.8

(51) Int. Cl. F03D 1/06; B29C 70/54; B29C 70/68; B29C 70/48

(52) U.S. Cl. CPC F03D 1/0675; B29C 70/48; B29C 70/54; B29C 70/68; B29C 70/681; B29K 2823/06; B29K 2995/0026; B29L 2031/08
USPC 416/230; 425/405.1; 264/571; 264/511

(57) ABSTRACT

A composite fibre component for a rotor blade of a wind power plant having a first surface, shaped in a predefined fashion, on a first side of the composite fibre component. The composite fibre component is developed such that the composite fibre component has a second surface, shaped in a predefined fashion, for connecting to a further component for the rotor blade on at least one partial area of a second side, facing away from the first side, of the composite fibre component. A manufacturing device for manufacturing a composite fibre component for a rotor blade of a wind power plant by using a vacuum infusion method, and to a method for manufacturing a composite fibre component for a rotor blade of a wind power plant by using a vacuum infusion method.

### BACKGROUND OF THE INVENTION

1. Field of the Invention

The invention relates to a composite fibre component for a rotor blade of a wind power plant having a first surface, shaped in a predefined fashion, on a first side of the composite fibre component.

Furthermore, the invention relates to a manufacturing device for manufacturing a composite fibre component for a rotor blade of a wind power plant using a vacuum infusion method comprising an open manufacturing mould with a mould surface for moulding a first surface on a first side of the composite fibre component.

Moreover, the invention relates to a method for manufacturing a composite fibre component for a rotor blade of a wind power plant using a vacuum infusion method in an open manufacturing mould, wherein a first surface on a first side of the composite fibre component is or will be moulded by means of a mould surface of the manufacturing mould.

The invention further relates to a rotor blade for a wind power plant as well as a method for manufacturing a rotor blade for a wind power plant.

2. Description of Related Art

Rotor blades for wind power plants made up of several individual parts, which are manufactured individually in composite fibre construction and are connected, for example adhered, to form a rotor blade, are known. The individual parts have in part considerable sizes and are usually planar, i.e. the thickness is considerably smaller than the length and the width.

Typical rotor blades consist of at least two rotor blade shells, which specify the outer shape and thus the important aerodynamic properties of the rotor blade. The rotor blade shells are normally reinforced in the area of the largest profile thickness of the rotor blade through so-called girders and are interconnected in the area of the girders through main webs or shear webs. The girders and the main webs or shear webs thereby form the main supporting structure of the rotor blade.

The so-called vacuum infusion technology has proven to be of value for the production of large individual parts in composite fibre construction. A dry fibre semi-finished material is first placed in an open mould, which specifies the final surface on one side of the individual part. The mould with the fibre semi-finished material is sealed using film and evacuated. The mould is then connected with a supply of resin, which is suctioned into the mould due to the negative pressure prevailing in the mould and saturates the fibre semi-finished material. After the hardening of the resin, the individual part can then be removed from the mould and further processed.

By means of the mould, a high quality, very well reproducible surface is realizable or respectively predefinable on one side of the component in this method, while a random and hardly influencable surface structure is formed on the other side of the component under the vacuum film. In this method, the thickness of the component is also only controllable in a relatively inexact manner.

For a rotor blade shell, for example, this means that the aerodynamically significant outside has a surface with an excellent quality, while the inside, onto which the main webs are adhered for example, is relatively rough and uneven. In order to even out these irregular structures on the adhesive connection, a generous amount of adhesive is applied for example to the inside of the rotor blade shell and a main web is pressed into the adhesive with a certain effort. The adhesive thereby evens out unevennesses between the components to be connected so that a planar connection exists between the components after hardening.

Due to the complex, generally curved shape of the components to be connected, transverse forces, which may result in a slipping of the parts to be adhered, are unavoidable during the pressing together. Accordingly, certain manufacturing inaccuracies negatively impacting the quality, stability and service life of the rotor blades produced as well as the reproducibility of these parameters in the case of several uniform rotor blades, must be accepted.

### BRIEF SUMMARY OF THE INVENTION

Based on this state of the art, the object of the present invention is to improve the quality, rigidity and/or service life of an individual rotor blade as well as the reproducibility of these properties for a plurality of uniform rotor blades.

This object is solved through a composite fibre component for a rotor blade of a wind power plant having a first surface, shaped in a predefined fashion, on a first side of the composite fibre component, which is developed in such a way that the composite fibre component has a second surface, shaped in a predefined fashion, for connecting to a further component for the rotor blade on at least one partial area of a second side of the composite fibre component facing away from the first side.

The second surface, shaped in a predefined fashion, is for example provided in that a composite fibre component manufactured by means of the described vacuum infusion method is post-treated on the second side.

It is achieved through the invention that the fit of two components to be interconnected for a rotor blade is improved. In particular, the invention enables that the second surface of the composite fibre component is designed with a complementary shape or in sections with a complementary shape to the further component. During the connection of the two components, for example through adhesion to said surface, the alignment of the components to each other is thereby simplified and the accuracy of the arrangement of the two components in the finished rotor blade is increased.

In the case of the invention, it is also no longer necessary that the composite fibre component and the further component need to be pressed together for the adhesion. An accidental slipping of the components relative to each other is thereby prevented.

A marking for a target position of the further component at or on the second surface is preferably arranged at or on the second surface of the composite fibre component. An exact alignment of the two components with respect to each other is hereby ensured during the connection of the two components. An inspection of the relative arrangement of the components with respect to each other after the connection is simultaneously enabled so that any production errors can be detected and corrected, if necessary. In particular, it is prevented that erroneously connected components are used for a rotor blade so that the overall quality of the finished rotor blades is improved.

In a particularly advantageous embodiment of the invention, the marking is designed as a stop, wherein in particular the further component is alignable or aligned in the target position in a form fitting manner to the stop. It is hereby ensured that the further component in the target position cannot slip before the final connection with the composite fibre component according to the invention.

The composite fibre component is preferably a rotor blade shell or a girder, wherein the further component is in particular a web or a main web. Web also has the meaning of shear web.

The object of the invention is also solved by a manufacturing device for manufacturing a composite fibre component for a rotor blade of a wind power plant using a vacuum infusion method comprising an open manufacturing mould with a mould surface for moulding a first surface on a first side of the composite fibre component, wherein the manufacturing device is thereby developed in that the manufacturing device comprises a mould insert with a mould surface for moulding a second surface for connecting the composite fibre component with a further component for the rotor blade, wherein the mould insert is arrangeable, to be arranged or arranged at or in the manufacturing mould such that the mould surface of the mould insert faces the mould surface of the manufacturing mould.

The manufacturing device according to the invention enables the manufacturing of a composite fibre component using a vacuum infusion method. The open manufacturing mould is thereby covered at least partially by the mould insert so that a cavity for the composite fibre component to be manufactured is designed between the manufacturing mould and the mould insert. The mould insert thereby preferably covers only a partial area of the entire manufacturing mould so that the size of the mould insert is smaller than the manufacturing mould. An easy-to-handle mould insert with a relatively low weight is thereby provided, which is nonetheless sufficiently stable for the formation of a defined and reproducible cavity for the composite fibre component.

This cavity is preferably completely filled with resin during the manufacturing of the composite fibre component so that a surface that is shaped in a predefined fashion and that is reproducible is shaped respectively on a side of the composite fibre component by the mould surface of the manufacturing mould and on the opposite side of the composite fibre component by the mould surface of the mould insert.

The mould surface of the mould insert preferably has a marking mould, for example an elevation or a recess, for moulding a marking for a target position of the further component at or on the second surface of the composite fibre component. In this manner, a marking is provided at or on the second surface of the composite fibre component during the manufacturing of the composite fibre component using a vacuum infusion method without further effort at an exactly specified and reproducible location.

It is also advantageous if the mould insert is designed transparent at least in sections. This makes it possible to observe and check the distribution of resin in the manufacturing mould during the vacuum infusion process.

One material of the mould insert preferably comprises polyethylene. Such materials are usually self-separating when using epoxy resins so that easy demoulding is ensured after hardening of the finished composite fibre component. In particular the mould surface of the mould insert thus thereby advantageously comprises a material with polyethylene or is made of such a material. Mould inserts or components for mould inserts can also be made simply and cost-effectively of polyethylene, for example using a deep drawing method.

A particularly preferred manufacturing device is characterized in that a positioning apparatus for the reproducible positioning of the mould insert at or in the manufacturing mould is included. A particularly exact and reproducible alignment of the mould insert relative to the manufacturing mould is hereby achieved, whereby accuracy and reproducibility of the cavity between the manufacturing mould and the mould insert and thus the design of the composite fibre component to be produced between the first surface and the second surface are further improved.

Furthermore, a sealing apparatus for a common contact area of the manufacturing mould and the mould insert is preferably included. A contact area is for example an area or a line, on or along which the manufacturing mould and the mould insert are in contact. A sealing apparatus thereby seals the contact area so that the manufacturing mould upon incorporation of the mould insert can be sealed very quickly and simply for the vacuum infusion process.

The object of the invention is also solved through the use of a method for manufacturing a composite fibre component for a rotor blade of a wind power plant using a vacuum infusion method in an open manufacturing mould, wherein a first surface on a first side of the composite fibre component is or will be moulded by means of a mould surface of the manufacturing mould, wherein the method is developed in that, during the manufacturing of the composite fibre component, a mould insert is arranged on or in the manufacturing mould. Wherein, by means of a mould surface of the mould insert facing the mould surface of the manufacturing mould, a second surface for the connection of the composite fibre component with a further component for the rotor blade is or will be moulded on at least one partial area of a second side of the composite fibre component facing away from the first side.

This method is suitable in particular to be executed by means of the manufacturing device according to the invention described above.

A marking for a target position of the further component at or on the second surface is or will be advantageously designed at or on the second surface of the composite fibre component. This takes place for example in that following the introduction of resin into the manufacturing mould, which preferably takes place using the vacuum infusion method, a marking is applied at or on the second surface of the composite fibre component. For example, the marking is pressed or embossed into the resin before the final hardening or a marking is applied, for example adhered or painted onto the at least partially hardened resin.

In a preferred embodiment, the marking is or will be moulded by means of the mould surface of the mould insert, in particular by means of a marking mould of the mould surface. A separate procedural step for the application of the marking is hereby saved and errors in the positioning of the marking are avoided.

The open manufacturing mould for the vacuum infusion method is preferably sealed using the mould insert. The areas of the open manufacturing mould, which are not covered by means of the mould insert, are thereby sealed for example by means of a vacuum film. Alternatively, the entire manufacturing mould including the mould insert is covered and sealed by means of a vacuum film or the mould insert is applied or inserted only after the sealing of the entire manufacturing mould by means of a vacuum film.

The object of the invention is also solved through a rotor blade for a wind power plant with a composite fibre component according to the invention.

The object is also solved through a method for manufacturing such a rotor blade, wherein the composite fibre component is connected at the second surface with a further component for the rotor blade.

If the composite fibre component, in particular at or on the second surface, has a marking for a target position of the further component, an alignment of the composite fibre component and of the further component with respect to each other after the connection is preferably checked using the marking. Moreover, it is advantageous if the composite fibre component and the further component are aligned with respect to each other before the connection by means of the marking.

Further characteristics of the invention will become apparent from the description of embodiments according to the invention together with the claims and the included drawings. Embodiments according to the invention can fulfill individual characteristics or a combination of several characteristics.

### BRIEF DESCRIPTION OF THE DRAWINGS

The invention is described below, without restricting the general idea of the invention, using exemplary embodiments with reference to the drawings, whereby we expressly refer to the drawings with regard to all details according to the invention that are not explained in greater detail in the text. The figures show:

FIG. 1 is an elevation view of a wind power plant;

FIG. 2 is an elevation view schematically illustrating the joining two rotor blade shells and two main webs into a rotor blade from the state of the art;

FIG. 3 is an elevation view schematically illustrating the joining of two rotor blade shells according to the invention and two main webs into a rotor blade according to the invention;

FIG. 4 is a perspective view of a manufacturing device according to the invention in a perspective representation;

FIG. 5 is a sectional elevation view of the manufacturing device from FIG. 4 in a schematic sectional representation and

FIG. 6 is an elevation view that schematically illustrating the joining of two rotor blade shells and two main webs into a rotor blade according to the invention in another embodiment.

In the drawings, the same or similar elements and/or parts are provided with the same reference numbers in order to prevent the item from needing to be reintroduced.

### DETAILED DESCRIPTION OF THE INVENTION

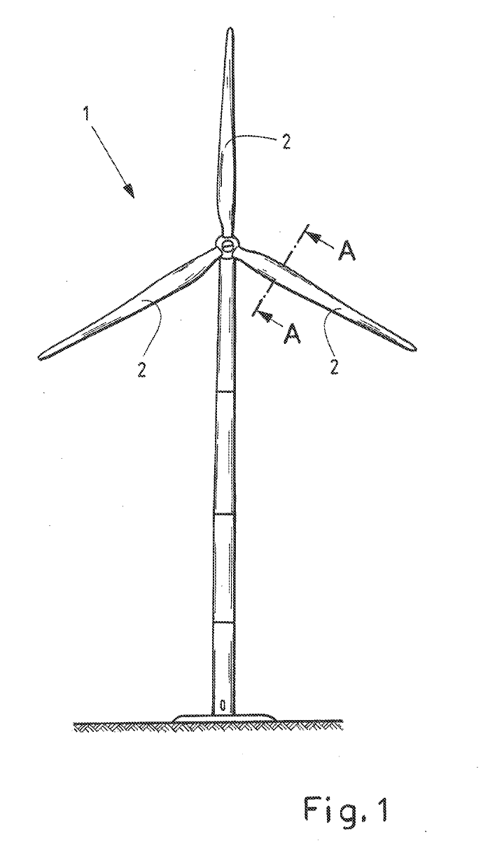

FIG. 1 shows schematically a typical wind power plant 1 with three rotor blades 2. A rotor blade 2 consists for example of several components produced in a composite fibre construction, which are adhered together.

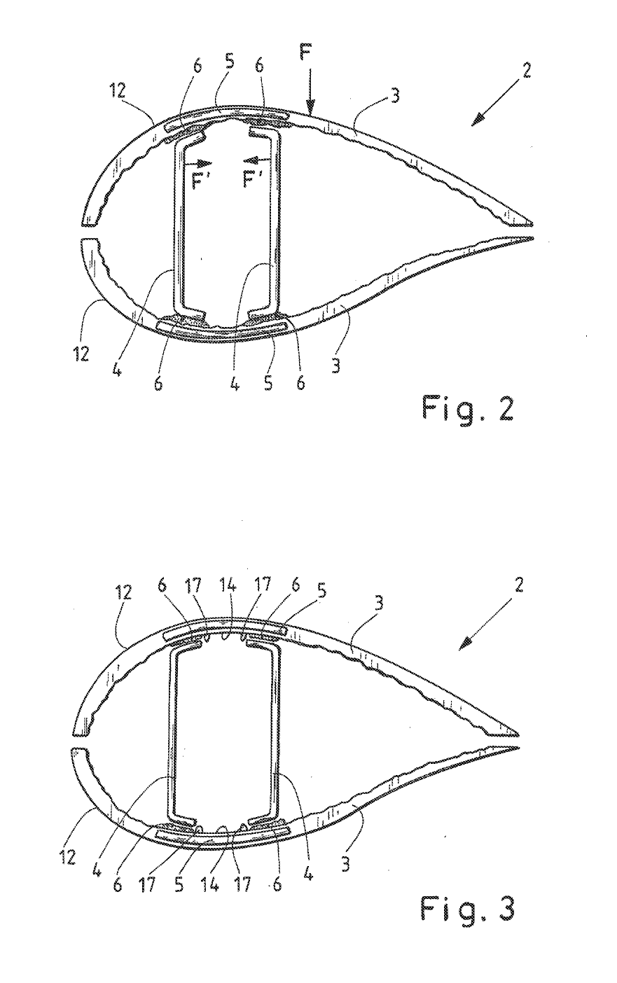

FIG. 2 shows schematically how a rotor blade 2 from the state of the art is joined together from two rotor blade shells 3 and two r gain webs 4. A sectional representation along the line A-A on the finished rotor blade in FIG. 1 is thereby shown.

The rotor blade shells 3 as well as the main webs 4 are produced individually in composite fibre construction using a vacuum infusion method. In this process, fibre material is placed in an open manufacturing mould, the manufacturing mould is sealed using a vacuum film, the air located between the manufacturing mould and the vacuum film is evacuated and resin is then directed into the evacuated manufacturing mould so that the fibre material between the manufacturing mould and the vacuum film is saturated with resin. After the hardening of the resin, the component manufactured in this manner has a defined surface, which is predefined by the surface of the manufacturing mould, on the side facing the manufacturing mould. In the rotor blade shells 3 shown in FIG. 2, this is the outside 11 or respectively the surface 12 of the outside 11.

On the opposite side, i.e. the side covered with the vacuum film during manufacturing, the final surface, however, is not controllable, For example, the flexible vacuum film forms folds, which are later full of resin, during evacuation of the manufacturing mould. In addition to the surface quality of the component on this side, the thickness of the component in the manufacturing process is thus also predefinable only within relatively rough inaccuracies. In the rotor blade shells 3 shown in FIG. 2, this is the inside 13 or respectively the surface of the inside 12.

For the stabilization of the rotor blade 2, a girder 5 is respectively incorporated into the rotor blade shells 3, wherein two main webs 4 are adhered between the girders 5 or respectively between the rotor blade shells 3 in the area of the girders 5. The main webs 4 have angled web feet on their edges, in order to enable a large-area adhesive connection with the rotor blade shells 3.

Adhesive 6 is applied to a rotor blade shell 3, into which the main webs 4 are pressed with their web feet, so that the adhesive 6 is distributed and unevennesses of the surface on the inside 13 of the rotor blade shell 3 are evened out by means of the adhesive 6. After the hardening of the adhesive 6, a planar connection is thus created between the first rotor blade shell 3 and the two main webs 4.

As the next step, which is shown in FIG. 2, the second rotor blade shell 3 is also provided with adhesive 6 and is placed onto the first rotor blade shell 3 with the adhered main webs 4. A certain compressive force F is also applied here in the direction of the shown arrow in order to push the main webs 4 into the adhesive 6 and to obtain a planar and loadable connection between the main webs 4 and the upper rotor blade shell 3. Due to the curved shape of the rotor blade shell 3, transverse forces act on the upper ends of the main webs 4 due to the exerted compressive force F, which lead to a compensation movement F′ of the main webs 4 relative to the upper rotor blade shell 3 in the direction of the represented arrows.

The compensation movement F′ can cause an impermissibly large deviation of the target position of the main webs 4 relative to the rotor blade shells 3 and/or the girders 5 and thereby impair the stability of the entire rotor blade. This risk is reduced by the invention.

FIG. 3 shows schematically the joining of a rotor blade 2 according to the invention with rotor blade shells 3 designed according to the invention.

A rotor blade shell 3 according to the invention for the rotor blade 2 according to the invention has on the outside 11 a surface 12, shaped in a predefined fashion, for the desired aerodynamic properties of the rotor blade 2. Moreover, the rotor blade shell 3 according to the invention also has on the inside 13 a surface 14, shaped in a predefined fashion, to which the main webs 4 are adhered. The surface 14, shaped in a predefined fashion, is thereby designed in particular with a complementary shape to the web feet of the main webs 4 so that the main webs 4 are insertable to fit accurately between the two rotor blade shells 3 according to the invention.

The invention also enables without great compressive forces a planar and loadable adhesive connection between the respective surfaces 14 of the two rotor blade shells 3 and the web feet of the two main webs 4.

This results in the further advantage that the rotor blade shells 3 and the main webs 4 of the rotor blade 2 can be adhered together in a single procedural step. The production duration and thus also the production costs of a rotor blade 2 according to the invention are thereby reduced.

On the surface 14, a preferred rotor blade shell 3 according to the invention has markings 17, which facilitate the relative positioning of main webs 4 and rotor blade shells 3 with respect to each other during adhesion and enable an inspection of the relative position on the finished rotor blade 2.

In the example shown in FIG. 3, the markings 17 are designed as stops for the web feet of the main webs 4 so that a supping of the web feet is excluded from the outset.

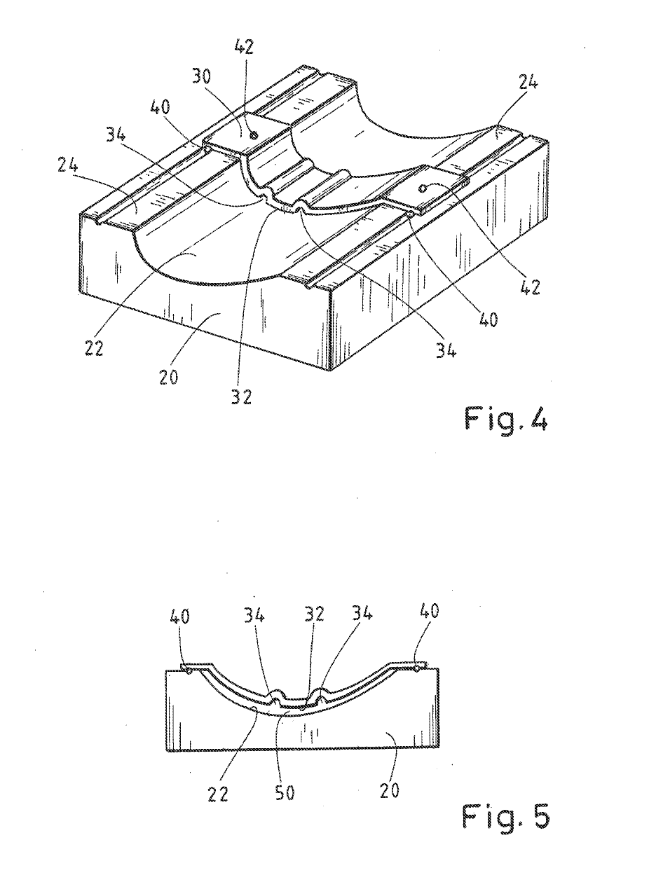

FIG. 4 shows schematically a device for manufacturing a rotor blade shell 3 according to the invention. The device comprises a manufacturing mould 20 with a first mould surface 22 for moulding the outer surface 12 of the rotor blade shell 3.

The device also comprises a mould insert 30 with a second mould surface 32 for a surface 14 on the inside of the rotor blade shell 3. The mould insert 30 is thereby placed on the edges 24 of the manufacturing mould 20 such that a cavity 50 is formed between the manufacturing r could 20 and the mould insert 30 as is shown in the sectional representation in FIG. 5. The cavity 50 is bordered by the mould surface 22 of the manufacturing mould 20 as well as the mould surface 32 of the mould insert 30.

For manufacturing a rotor blade shell 3, fibre material and other components for the rotor blade shell 3, for example a girder 5 or material for a sandwich core, are first placed on the mould surface 22 of the manufacturing mould 20. The mould insert 30 is then placed onto the manufacturing mould 20 or respectively onto the edge 24 of the manufacturing mould 20.

The correct positioning of the mould insert 30 on the edge 24 of the manufacturing mould 20 is ensured for example through suitable positioning apparatus 42. These are for example pins attached to the edges 24 of the manufacturing mould 20 and holes with a complementary shape for the pins on the mould insert 30.

The mould insert 30 is designed transparent at least in sections so that the distribution of the resin in the cavity 50 between the mould insert 30 and the manufacturing mould 20 is observable. In particular, air pockets can thereby be identified and corrected already during the resin infusion.

The mould insert 30 is produced, for example in an extrusion process, using a material with polyethylene. The mould insert 30 can thereby be produced easily and cost-effectively and, in particular because the mould insert 30 is considerably smaller than the manufacturing mould 20, also in a sufficiently stable manner.

In the exemplary embodiment shown in FIGS. 4 and 5, the mould insert 30 or respectively the mould surface 32 of the mould insert 30 has two marking moulds 34 in the form of grooves.

Next, the manufacturing mould 20 is sealed by means of a vacuum film.

For example, the mould insert 30 can thereby also be used for the sealing when a seal 40 is provided between the mould insert 30 and the manufacturing mould 20. For this, the manufacturing mould 20 shown as an example in FIGS. 4 and 5 has channels on the edges 24 for a seal 40, for example a hose seal made of rubber.

After the sealing of the manufacturing mould 20, the fibre material and other materials for the rotor blade shell 3 located in the manufacturing mould 20 are saturated with resin using a vacuum infusion method.

During the infusion of the resin, the cavity 50 between the mould insert 30 and the manufacturing mould 20 is completely effused with resin so that a surface 14 of the rotor blade shell 3 is predefined or respectively shaped in a defined manner by means of the mould surface 32 of the mould insert. The grooves of the marking moulds 34 are thereby also filled with resin so that, after the hardening of the resin, markings 17 are provided for the target position of the main webs 4 on the rotor blade shell 3.

In an alternative manufacturing process, the material for the rotor blade shell 3 is placed in the manufacturing mould 20, the entire manufacturing mould 20 is sealed by means of a vacuum film, the manufacturing mould under the vacuum film is evacuated and the material for the rotor blade shell 3 is saturated with resin in a vacuum infusion process. Then, before the hardening of the resin, the mould insert 30 is placed and pressed onto the manufacturing mould so that the still-liquid resin under the vacuum film is modelled or respectively shaped by means of the mould surface 32 of the mould insert 30. This also results in a surface 14, shaped in a predefined fashion, on the inside 13 of the rotor blade shell 3.

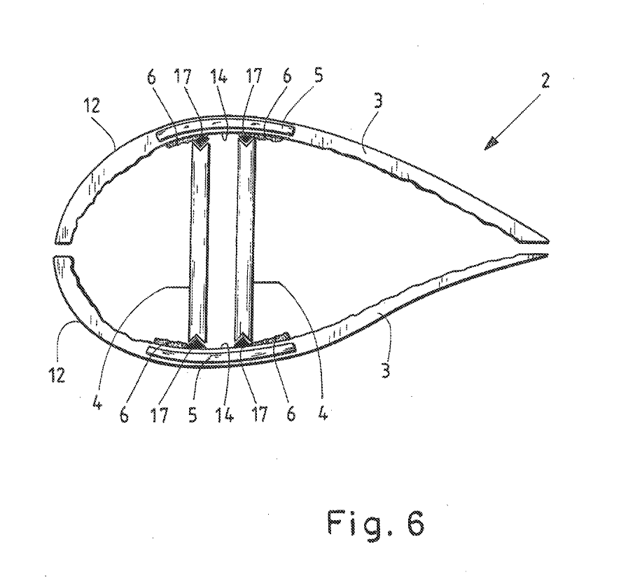

FIG. 6 schematically shows the joining of two rotor blade shells 3 according to the invention and two main webs 4 into a rotor blade 2 according to the invention in a further embodiment that differs from the embodiment from FIG. 3. In this embodiment, the main webs 4 have for example a Y shape on their ends, which fit into the markings 17 or respectively onto the marking 17.

The markings 17 are preferably complementary in shape to the ends of the main webs 4 or respectively the main webs 4 are at least partially on their ends complementary in shape to the markings 17. In particular through this measure, a very accurate positioning of the main webs 4 is possible during the joining of the rotor blade shells 3 according to the invention.

All named characteristics, including those taken from the drawings alone and individual characteristics, which are disclosed in combination with other characteristics, are considered alone and in combination as essential for the invention. Embodiments according to the invention can be fulfilled through individual characteristics or a combination of several characteristics.

### LIST OF REFERENCES

1 Wind power plant
2 Rotor blade
3 Rotor blade shell
4 Main web
5 Girder
6 Adhesive
11 Outside
12 Surface shaped in a predefined fashion
13 Inside
14 Surface shaped in a predefined fashion
17 Marking
20 Manufacturing mould
22 Mould surface
24 Edge
30 Mould insert
32 Mould surface
34 Marking mould
40 Seal
42 Positioning apparatus
44 Vacuum film
50 Cavity
F Compressive force
F Compensation movement

What is claimed is:

1. A composite fibre component for a rotor blade of a wind power plant, the composite fibre component comprising:
a first surface, shaped in a first predefined fashion, on a first side of the composite fibre component; and
a second surface, shaped in a second predefined fashion, for connecting to a further component for the rotor blade on at least one partial area of a second side, facing away from the first side of the composite fibre component.

2. The composite fibre component according to claim 1, further comprising a marking for a target position of the further component on the second surface that is arranged on the second surface.

3. The composite fibre component according to claim 2, wherein the marking is a stop, and wherein the further component is aligned in the target position in a form-fitting manner with the stop.

4. The composite fibre component according to claim 1, wherein the composite fibre component is at least one of a rotor blade shell and a girder, and wherein the further component is at least one of a web and a main web.

5. A manufacturing device for manufacturing a composite fibre component for a rotor blade of a wind power plant using a vacuum infusion method, the manufacturing device comprising:
an open manufacturing mould with a manufacturing mould mould surface for moulding a first surface on a first side of the composite fibre component; and
a mould insert with a mould insert mould surface for moulding a second surface for connecting the composite fibre component with a further component for the rotor blade, wherein the mould insert is arranged in the manufacturing mould such that the mould surface of the mould insert faces the mould surface of the manufacturing mould.

6. The manufacturing device according to claim 5, wherein the mould surface of the mould insert has a marking mould for moulding a marking for a target position of the further component on the second surface of the composite fibre component.

7. The manufacturing device according o claim 5, wherein the mould insert is transparent at least in sections.

8. The manufacturing device according to claim wherein one material of the mould insert comprises polyethylene.

9. The manufacturing device according to claim 5, further comprising a positioning apparatus for reproducible positioning of the mould insert in the manufacturing mould and a sealing apparatus for a common contact area of the manufacturing mould and the mould insert.

10. A method for manufacturing a composite fibre component for a rotor blade of a wind power plant using a vacuum infusion method in an open manufacturing mould, comprising:
moulding a first surface on a first side of the composite fibre component with a mould surface of the manufacturing mould;
arranging a mould insert in the manufacturing could during the manufacturing of the composite fibre component; and
moulding a second surface for connecting the composite fibre component with a further component for the rotor blade to at least a partial area of a second side of the composite fibre component facing away from the first side with a mould surface of the mould insert that faces the mould surface of the manufacturing mould.

11. The method according to claim 10, wherein a marking for a target position of the further component on the second surface is on the second surface of the composite fibre component.

12. The method according to claim 11, wherein the marking is moulded by the mould surface of the mould insert.

13. The method according to claim 10, wherein the open manufacturing mould for the vacuum infusion method is sealed using the mould insert.

14. A rotor blade for a wind power plant with a composite fibre component according to claim 1.

15. A method for manufacturing a rotor blade according to claim 14, wherein the composite fibre component is connected at the second surface with a further component for the rotor blade.

16. The method according to claim 15, wherein the composite fibre component has a marking, and wherein an alignment of the composite fibre component and the further component with respect to each other is checked after the connection using the marking.

17. The method according to claim 15, wherein the composite fibre component and the further component are aligned with each other before connection by the marking.

18. The method according to claim 11, wherein the marking is moulded by a marking mould of the mould surface.
